(19) United States
(12) Patent Application Publication
(10) Pub. No.: US 2007/0263109 A1
(43) Pub. Date: Nov. 15, 2007

(54) Imager integrated CMOS circuit chip and associated optical code reading systems

(76) Inventors: Bradley S. Carlson, Northport, NY (US); Raj Bridgelall, Mount Sinai, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/879,051

(22) Filed: Jul. 16, 2007

Related U.S. Application Data
(63) Continuation of application No. 09/843,946, filed on Apr. 30, 2001.

(51) Int. Cl. H04N 5/30

(52) U.S. Cl. 348/308

(57) ABSTRACT

Monolithic circuit chips are disclosed which are particularly adapted for use with barcode reading, video and photographic systems. The monolithic circuit chip can include a sensor array, digitizer and decoder. The monolithic circuit chip can alternatively include an imager circuit, radio frequency circuit and memory. The memory can be one of ferroelectric random access memory (FRAM), E²PROM, or Flash memory. The monolithic circuit chip can be formed using complementary metal oxide semiconductor (CMOS) techniques.

### FIELD OF INVENTION

The present invention relates to a monolithic integrated circuit chip. More specifically, the present invention relates to a monolithic complementary metal oxide semiconductor (CMOS) circuit chip which incorporates a sensor array, digitizer and decoder. Further the present invention relates to a CMOS circuit chip which incorporates signal processing, image capture and radio frequency communication on a single chip.

### BACKGROUND OF INVENTION AND OBJECTS

Since the advent of the integrated circuit chip it has been desired to integrate as many components as possible onto the same circuit chip. The integration of components on the same circuit chip allows the sharing of components formed on the circuit chip, thereby reducing costs. Further, the integration of various components on the same circuit chip increases speed and efficiency of the exchange of information between the various components because the parasitic resistance and capacitance between components is significantly smaller when the components are on the same chip. For example, if an analog-to-digital converter and a microprocessor are formed on separate circuit chips, the amount of information exchanged between the analog-to-digital converter and the microprocessor is limited by the speed of a bus which connects the analog-to-digital converter to the microprocessor. Accordingly, integrating an analog-to-digital converter on the same circuit chip as a microprocessor increases the amount of information which can be exchanged between the two components.

It will be recognized that CMOS technology is currently the fabrication process used to make most integrated circuits today. One type of integrated circuit chip which employs CMOS technology to increase the number of components formed on the same circuit chip is a CMOS imager. Conventionally, most imagers were constructed as charged coupled device (CCD) imagers. The manufacturing of conventional CCD imagers is a specialized process which does not integrate well to the addition of peripheral circuitry, e.g., timing generators, decoders, multiplexers and analog-to-digital converters, on the same chip as the CCD device. Further, depending upon the type of device being used, a CCD imager may require multiple bias voltages and high-power phase clocks to operate. Accordingly, to obtain an image from a CCD imager requires additional hardware which increases a unit's power consumption, size and cost.

There are currently two different types of CMOS imagers known today, active pixel sensor (APS) and active column sensor (ACS) imagers. APS CMOS imagers are constructed by placing an amplifier inside each pixel. The placement of the amplifier inside each pixel reduces the light gathering portion of the pixel, i.e., the fill factor of each pixel, and reduces the dynamic range of the pixel. In addition, variations in the manufacturing process of APS CMOS imagers cause a fluctuation in the gain and offset of each of the amplifiers. These fluctuations may result in each pixel responding differently to the same amount of input light. The different responses of each pixel can create noise.

ACS CMOS imagers employ a true unity gain amplifier which is shared by each pixel in each column of pixels. As compared to APS CMOS imagers, ACS CMOS imagers use only an input transistor inside each pixel. APS CMOS imagers' use of only an input transistor inside each pixel, as compared to the use of an amplifier inside each pixel as in APS CMOS imagers, increases the fill factor and dynamic range of the imager. The additional space provided to the amplifiers in APS CMOS imagers, by not being required to be inside each pixel, allows the implementation of high-quality amplifiers. Further, these high-quality amplifiers, being true unity gain with feedback, virtually eliminate the pixel-to-pixel gain variations of APS CMOS imagers.

Another area where CMOS technology is used to increase the number of components formed on the same circuit chip is in the area of memory systems. The recent increased demand for portable electronic devices has increased demand for smaller more versatile memory systems. This is due in part to the limited power supplies employed by these portable electronic devices. For example, portable electronic devices typically rely upon batteries to power the devices. In these devices it is desirable to maintain information in memory systems when the portable electronic device is powered off. Memory systems which can store information without power are known as non-volatile memory systems. Two known types of non-volatile memory systems are E²PROM and flash memory.

Another type of memory system which can be implemented using CMOS techniques is ferroelectric random access memory (FRAM). FRAM provides write times which exceed those of conventional memory systems. Further, FRAM only requires 1 mA of operating current which is less power than is required for other types of conventional memory systems. The reduced operating power is advantageous in electronic portable devices due to the limited power supplies of these devices.

To form FRAM in CMOS, ferroelectric material is deposited after the CMOS device has been formed. The deposition of the ferroelectric material does not require a high-temperature treatment. Other formation techniques which require deposition during the formation of the CMOS device and high temperature treatment can alter the source and drain diffusion depths of the CMOS. FRAM technology is discussed generally in Auciello et al., “The Physics of Ferroelectric Memories”, Physics Today, July 1998.

Accordingly, it is an object of the present invention to reduce the costs and packing size of imaging devices.

It is also an object of the present invention to provide a monolithic circuit chip which integrates various components which previously have been formed on separate circuit chips.

It is a further object of the present invention to provide a monolithic circuit chip which provides multiple sensing and signal processing functions used in the reading of optical codes.

These and other objects and features of the invention will be apparent from this written description and the drawings.

### SUMMARY OF THE INVENTION

The present invention relates to methods and apparatus useful in optical code readers and camera systems. Techniques are disclosed which are applicable to the design of solid state die packages for code readers and cameras of various types.

In a preferred embodiment of the present invention a photo sensor array for an optical code reader or camera system is formed on the same monolithic circuit chip as a digitizer and a decoder. The apparatus can be either a linear array for detecting one-dimensional bar code symbols or an area array for imaging two dimensional optical code symbols or objects or scenes.

In another preferred embodiment of the present invention an imager for an optical code reader or camera system is formed on the same monolithic circuit chip as a processor, memory and radio frequency transceiver. In accordance with this embodiment of the present invention, the processor, radio frequency transceiver and imager are formed on the monolithic circuit chip in accordance with complementary metal oxide semiconductor (CMOS) techniques. Further, the memory can be formed from ferroelectric random access memory (FRAM), flash or E²PROM. The radio frequency transceiver and imager can share components on the monolithic circuit chip for processing the signals received by the transceiver and imager.

The foregoing is intended as a convenient summary of the present disclosure. However, the aspects of the invention sought to be protected are set forth in the claims.

### BRIEF DESCRIPTION OF THE DRAWINGS

The objects and advantages of the invention will be understood by reading the following detailed description in conjunction with the drawings, in which:

FIG. 1 illustrates a sensor array, digitizer and decoder formed on a single monolithic circuit chip in accordance with one embodiment of the present invention;

FIG. 2 illustrates a conventional arrangement of signal processing, image capture and radio frequency communication functions; and

FIG. 3 illustrates an arrangement of signal processing, image capture and radio frequency communication functions on a single monolithic circuit chip in accordance with one embodiment of the present invention.

### DETAILED DESCRIPTION

The various features of the invention will now be described with reference to the figures, in which like parts are identified with the same reference characters.

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

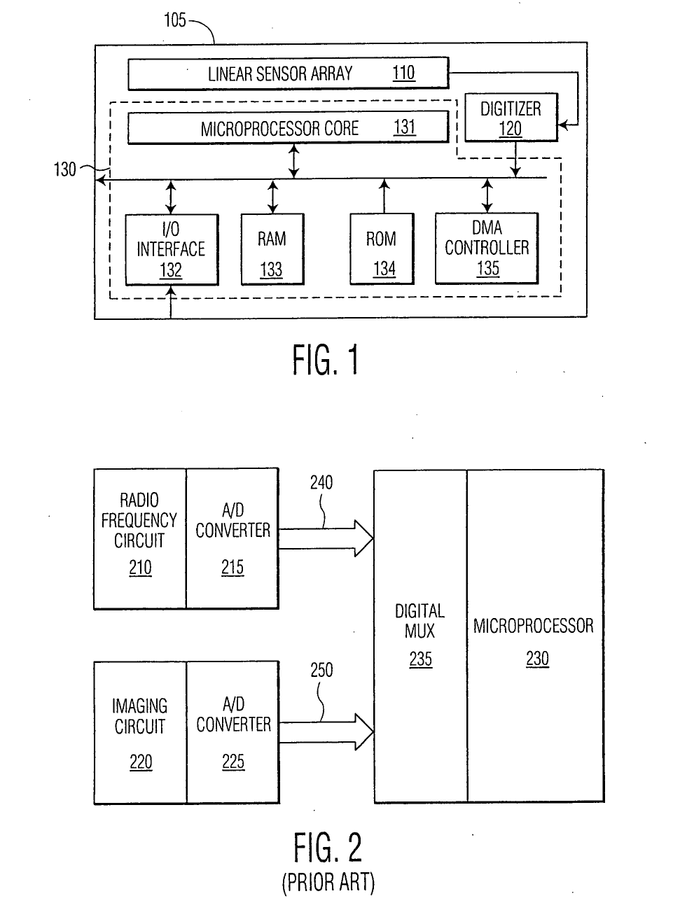

FIG. 1 illustrates a sensor array, digitizer and decoder formed on a single monolithic circuit chip in accordance with one embodiment of the present invention. The circuit chip 105 includes a linear sensor array 110, a digitizer 120 and a decoder 130. The decoder 130 includes a microprocessor core 131, and in/out (I/O) interface 132, random access memory (RAM) 133, read only memory 134 and direct memory access controller 135. In accordance with the present invention, incoming light, such as from a one dimensional bar code, is focused on the linear sensor array 110. The array passes an analog version of the received light to digitizer 120. The digitizer can be an A/D converter, or a more complicated signal processor. The entire image can be stored in memory and the waveform can be digitized in software using the microprocessor. Digitizer 120 can be a “high blur” digitizer (i.e., a digitizer which can extract a digital replica of a sequences of bars and spaces from a highly blurred image of the bar code). Such a digitizer can be constructed in accordance with U.S. patent application Ser. No. 09/096,164 to He et al. filed Jun. 12, 1998, entitled “Digitizing Barcode Symbol Data” and assigned to Symbol Technology, Inc. The He et al. patent is hereby expressly incorporated by reference herein.

After digitizing the received image, the digitizer forwards the digital image to decoder 130 for further processing. Decoder 130 can be implemented as a barcode scanner decoder using conventional decoding algorithms. Upon receiving the digitized image, the decoder 130 stores the digitized information in RAM 133 during the decoding process. The microprocessor core 131 retrieves the stored information from RAM 133 and decodes the information in accordance with instructions stored in ROM 134. The accessing of RAM 133 and ROM 134 by the microprocessor core is controlled by DMA controller 135. Once the information is decoded by microprocessor core 131, the decoded information is stored in RAM 133. The decoded image can be output to a computer, or other processing device, via I/O interface 132.

The combination of a sensor array, digitizer and decoder on the same monolithic circuit chip reduces the complexity, size and cost compared to systems where the sensor array, digitizer and/or decoder are implemented on separate circuit chips. This reduced complexity, size and cost is particularly advantageous in barcode scanner and low-cost video or photographic applications. In accordance with exemplary embodiments of the present invention, the monolithic circuit chip 105 is constructed using CMOS technology. Although FIG. 1 has been described as using a linear sensor array, it will be recognized that area array, i.e., a 2 dimensional array, can be substituted for the linear sensor array.

Another embodiment of the present invention relates to a monolithic CMOS circuit chip which incorporates signal processing, image capture and radio frequency communication on a single chip. FIG. 2 illustrates a conventional arrangement of signal processing, image capture and radio frequency communication components. As illustrated in FIG. 2, this arrangement includes radio frequency circuit 210, imaging circuit 220 and microprocessor 230. Radio frequency circuit 210 and imaging circuit 220 respectively incorporate analog-to-digital converters 215 and 225. Microprocessor 230 includes a digital multiplexer (MUX) 235.

In the arrangement illustrated in FIG. 2, radio frequency circuit 210 transmits and receives radio frequency signals. When radio frequency circuit 210 receives radio frequency signals, the circuit 210 removes the radio frequency carrier and converts the remaining signal to baseband. Radio frequency circuit 210 uses analog-to-digital converter 215 to convert the baseband signal from analog to digital. The digital signal is then sent over bus 240 to microprocessor 230.

Imaging circuit 220 is a CCD or CMOS imager. Accordingly, imaging circuit 220 receives an image and uses analog-to-digital converter 225 to convert the received image into digital form. The digital image is sent over bus 250 to microprocessor 230. Microprocessor 230 receives, via digital multiplexer 235, digital signals from radio frequency circuit 210 or from imaging circuit 220.

Since radio frequency circuit 210 and imaging circuit 220 are located on separate circuit chips from that of microprocessor 230, external leads must be used to connect radio frequency circuit 210 and imaging circuit 220 to microprocessor 230. The use of external leads increases the chance of breakage of the connection between these components. Further, the external leads reduce the throughput of data between the components. In addition, since radio frequency circuit 210 and imaging circuit 220 are located on separate chips, each circuit requires its own digital-to-analog converter. This duplication in parts increases the cost of the resultant device and increases the power consumption of the resultant device. The use of separate circuits chips also increases the manufacturing and packaging costs of the resultant device.

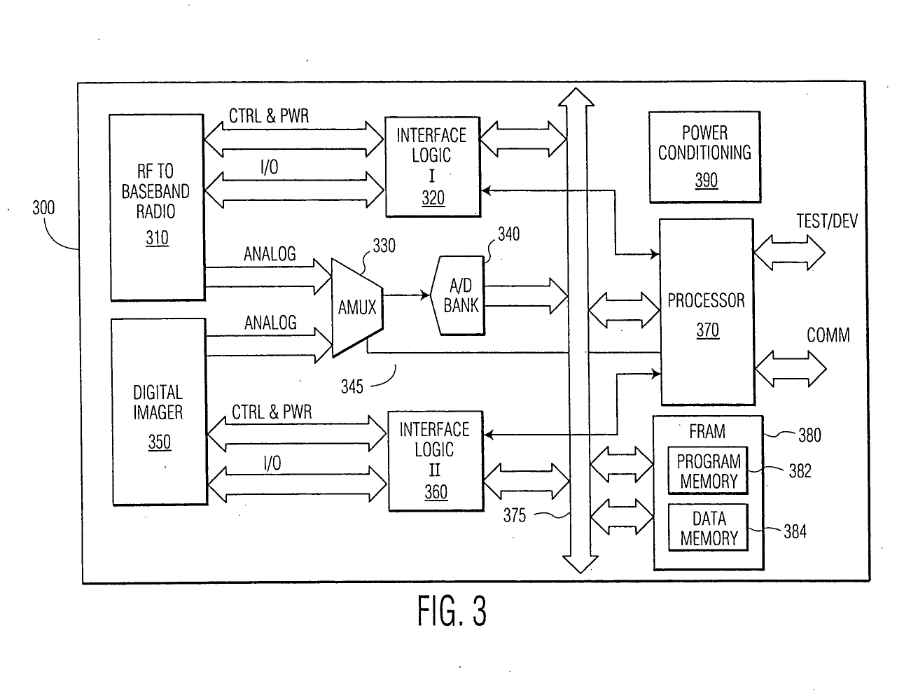

FIG. 3 illustrates an exemplary monolithic circuit chip in accordance with the present invention. The monolithic circuit chip 300 includes RF to baseband radio circuit 310, interface logic I 320, analog multiplexer (AMUX) 330, analog-to-digital (A/D) converter bank 340, digital imager 350, interface logic 360, processor 370, FRAM 380 and power conditioning circuit 390. Although memory 380 is illustrated in FIG. 3 as FRAM, this memory can alternatively be either Flash memory or E²PROM. In accordance with exemplary embodiments of the present invention, RF to baseband radio circuit 310 operates in accordance with known wireless local access network (WLAN) standards such as Bluetooth, IEEE 802.11 and HomeRF. Bluetooth is an ad-hoc wireless networking technology which is designed to eliminate cables between devices. IEEE 802.11 is a wireless networking technology designed to replace regular wired networks. HomeRF is based upon a shared wireless access protocol which combines voice and data information over the air interface.

In accordance with the present invention, RF to baseband radio circuit 310 receives radio signals, removes the radio frequency carrier and converts the radio frequency signal to a baseband signal. The signal is passed from RF to baseband radio circuit 310 via the analog bus to analog multiplexer (AMUX) 330. The multiplexed information is passed to analog to digital (A/D) converter bank 340. The digital information can then be placed on bus 375 so that the first interface logic 320 or processor 370 can perform further processing of the information.

The first interface logic 320 can receive the digital information from bus 375 and depacketize the digital baseband information. The depacketized digital baseband signal can then be communicated to processor 370 over bus 375. Alternatively, processor 370 can receive the packetized digital baseband information from bus 375 and can depacketize the signal. The first interface logic 320 can set registers and flags in the RF to baseband radio circuit 310 via the I/O bus connecting the two circuits. RF to baseband radio circuit 310 is controlled and receives power from the first interface logic 320 via the Cntrl & PWR line.

If digital imager circuit 350 outputs analog information, e.g., if digital imager circuit 350 is a charged coupled device (CCD), digital imager circuit 350 provides an analog image signal to the analog multiplexer 330. The multiplexed information is passed to A/D converter bank 340. The digital information can then be placed on bus 375 so that the second interface logic 360 or processor 370 can perform further processing of the information.

If digital imager 350 outputs digital information, digital imager 350 provides second interface logic circuit 360 with the digital image, via the I/O bus connecting the two circuits. The second interface logic circuit 360 can processes samples of the digital image and provide the samples to processor 370. Processor 370 can process the image data if necessary. For example, processor 370 can perform compression, decompression, filtering and other functions inherent in image processing. Digital imager circuit 350 is controlled and receives power from the second interface logic 360 via the Cntrl & PWR line.

Processor 370 operates in connection with FRAM 380. FRAM 380 includes program memory 382 and data memory 384. Program memory 382 is a read only memory and stores the instructions for operation of the processor 370, RF to baseband circuit 310 and digital imager 350. Data memory 384 is used to store information by the processor 370, including received radio information and digital image information. Processor 370 controls the path selecting for the analog multiplexer via control line 345. Testing of the processor 370 can be performed by sending test signals over the Test/Dev bus. Additionally, communication with external circuits and other devices is achieved via the Comm bus. Power conditioning circuit 390 converts the circuit chip's input power into the amount of power required for the various components formed on the circuit chip.

The first and second interface logic 320 and 360 are illustrated as separate components for ease of explanation. However, components of these logic circuits can be shared. For example, in a preferred embodiment the RF to baseband radio circuit 310 and the digital imager circuit 350 may share the same components for signal compression and decompression which is used in image processing and RF decoding. Further, fast Fourier transform (FFT) and inverse fast Fourier transform (IFFT) algorithms which are used for feature extraction from images and RF signals can be performed using shared components. In addition, analog-to-digital converters, filters, correlators, accumulators and shift registers which are used to process the image and RF signals can be provided using circuit shared between the RF to baseband radio circuit 310 and digital imager circuit 350.

Because of the low cost of the integrated circuit chip described above in connection with FIG. 3, there are many applications for the integrated circuit chip. For example, the integrated circuit chip can be used for remote and real-time surveillance over the Internet. Accordingly, the digital imager circuit 350 can capture images which are processed and provided to the RF to baseband radio circuit 310. The RF to baseband radio circuit 310 can communicate, using one of the above-described wireless access protocols, with a server which is connected to the Internet. The integrated circuit chip can be used to monitor a home for security purposes, a business for security purposes, day care facilities, and traffic. In addition, the integrated circuit chip can be used for aerial video/photography.

Another exemplary application of the integrated circuit chip described above in connection with FIG. 3 is for parking garages. For example, cameras, which incorporates the integrated circuit chip of FIG. 3, may be sufficiently inexpensive that they can be deployed to monitor one or a few parking spaces in a parking garage. Since each camera also includes an RF to baseband radio circuit 310, a wireless network can be formed between the cameras which monitor the parking spaces. The wireless network can also include a server which collects the images from each of the cameras and compiles a list of available parking spaces. Accordingly, if an automobile is also equipped with a RF radio transceiver which operates using the same access protocols as the server, the automobile can be provided with a map of open parking spaces by the server upon entering the parking garage. In accordance with exemplary embodiments of the present invention, the cameras and server operate in accordance with Bluetooth wireless access protocols. It will be recognized that the above-described parking system can also be applied to street parking.

As a complement to the above-described parking garage implementation of the present invention, a billing system for use of parking spaces can be provided. For example, the integrated circuit chip illustrated in FIG. 3 can be equipped with a radio frequency identification (RFID) reader. Accordingly, when a automobile equipped with an RFID tag enters a parking space the RFID reader in the integrated circuit chip reads the RFID tag and records the length of time that the automobile is parked. The information stored on the RFID tag can then be used to bill the owner of the automobile for the use of the parking space.

The invention has been described herein with reference to particular embodiments. However, it will be readily apparent to those skilled in the art that it may be possible to embody the invention in specific forms other than those described above. This may be done without departing from the spirit of the invention. Embodiments described above are merely illustrative and should not be considered restrictive in any way. The scope of the invention is given by the appended claims, rather than the preceding description, and all variations and equivalents which fall within the range of the claims are intended to be embraced therein.

1-18. (canceled)

19. A monolithic circuit chip comprising:
a sensor array;
a digitizer for digitizing the captured images; and
decoder for decoding the digitized images, wherein the digitizer performs a method for use in processing an analog electrical signal containing information representative of reflected light from indicia including regions of different light reflectivity, wherein the analog electrical signal contains edge transitions corresponding to boundaries between adjoining regions of different light reflectivity of the indicia, the method comprises:
analyzing the edge transitions of at least a part of the analog electrical signal to determine a level of blur in that part of the analog electrical signal; and
based on the determined level of blur, selecting one of a plurality of different techniques for processing that part of the analog electrical signal to produce a digitized electrical signal in which transitions in the digital level of the signal correspond to boundaries between adjoining regions of different light reflectivity of the indicia.

20. The monolithic circuit chip of claim 19, wherein the step of analyzing the edge transitions is performed on a plurality of different parts of the analog electrical signal and different digitizing techniques are used on the different parts of the analog signal depending on the level of blur in the different parts of the analog signal.

21. The monolithic circuit chip of claim 19 further comprising:
ranking the edge transitions by magnitude; and
analyzing the ranked edge transitions to detect the extent of blur represented in the part of the analog electrical signal.

22. The monolithic circuit chip of claim 21, wherein the ranking is done by forming a histogram of the magnitudes of the edge transitions.

23. The monolithic circuit chip of claim 21, further comprising if the part of the analog electrical signal has edge transitions of substantially different magnitudes, determining that significant blur is represented in that part of the analog electrical signal.

24. The monolithic circuit chip of claim 23, further comprising rejecting edge transitions having less than a threshold magnitude.

25. The monolithic circuit chip of claim 23, further comprising:
grouping the edge transitions into sets by magnitude; and
testing whether the difference between a first magnitude associated with a first set and a second magnitude associated with a second set is substantially equal to the difference between the first magnitude and a third magnitude associated with a third set.

26. The monolithic circuit chip of claim 19, wherein the sensor array, digitizer and decoder are formed on the monolithic circuit chip using complementary metal oxide semiconductor (CMOS) techniques.

27. The monolithic circuit chip of claim 19, wherein the decoder comprises a processor and memory.

28. The monolithic circuit chip of claim 19, wherein the sensor array is a linear array of cells for capturing light reflected by a one dimensional bar code symbol.

29. The monolithic circuit chip of claim 19, wherein the sensor array is an area sensor array for capturing two dimensional images.

30. A monolithic circuit chip comprising:
a sensor array;
a digitizer for digitizing the captured images; and
decoder for decoding the digitized images, wherein the digitizer performs a method for use in processing an analog electrical signal containing information representative of reflected light from indicia including regions of different light reflectivity, wherein the analog electrical signal contains edge transitions corresponding to boundaries between adjoining regions of different light reflectivity of the indicia, the method comprises:
determining whether an edge transition corresponds to a boundary between adjoining regions of substantially equal width; and
based on the determination, producing a digitized electrical signal in which transitions in the digital level of the signal correspond to the boundaries between adjoining regions of different light reflectivity of the indicia.

31. The monolithic circuit chip of claim 30, further comprising determining whether at least a part of the analog electrical signal is inconsistent with an alternating dark-and-light feature of a bar code symbol.

32. The monolithic circuit chip of claim 31, further comprising if the inconsistency is found, rejecting at least that part of the analog electrical signal.

33. The monolithic circuit chip of claim 30, further comprising determining whether a part of the analog electrical signal crosses a magnitude threshold more than once.

34. The monolithic circuit chip of claim 33, further comprising if the part is found to cross the magnitude threshold more than once, rejecting at least the part of the analog electrical signal.

35. The monolithic circuit chip of claim 30, further comprising determining the extent to which an edge transition that corresponds to a boundary between two adjoining regions of different widths is affected by one of the regions.

36. The monolithic circuit chip of claim 30, wherein the sensor array, digitizer and decoder are formed on the monolithic circuit chip using complementary metal oxide semiconductor (CMOS) techniques.

37. The monolithic circuit chip of claim 30, wherein the sensor array is a linear array of cells for capturing light reflected by a one dimensional bar code symbol.

38. The monolithic circuit chip of claim 30, wherein the sensor array is an area sensor array for capturing two dimensional images.
